(19) United States
(12) Patent Application Publication
(10) Pub. No.: US 2013/0270081 A1
(43) Pub. Date: Oct. 17, 2013

(54) Key Pad Structure of Keyboard and Method for Manufacturing the Same

(71) Applicant: Chang-Lung WU, Keelung City (TW)

(72) Inventor: Chang-Lung WU, Keelung City (TW)

(21) Appl. No.: 13/862,107

(22) Filed: Apr. 12, 2013

(30) Foreign Application Priority Data
Apr. 12, 2012 (TW) 101113089

(51) Int. Cl. H01H 13/14; H01H 11/00; H01H 13/02

(52) U.S. Cl. CPC H01H 13/14; H01H 13/023; H01H 11/00
USPC 200/314; 200/344; 29/622

(57) ABSTRACT

The present invention provides a key pad structure for a keyboard. The key pad structure comprises a circuit board, an elastic portion, a key cap and a supporting structure. The elastic portion is disposed on the circuit board that has a plurality of through holes. The key cap is disposed above the elastic portion. Additionally, the supporting structure is partially pivoted within the through holes and below the key cap. The supporting structure allows the key cap to move in a linear up-and-down motion with respect to the circuit board. In detail, when the key cap moves downwards from an initial position, the switch of the circuit board is thus, activated. Then, the key cap moves upwards to return to the initial position from the resilience provided from the elastic portion.

This application claims benefits from the priority of Taiwan Patent Application No. 101113089 tiled on Apr. 12, 2012; the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention provides a key pad structure and a method for manufacturing the same, and more particularly, to the key pad structure of a keyboard and a method for manufacturing the same.

2. Descriptions of the Related Art

Out of the currently available human-machine interfaces and systems, keyboards are indispensable input devices. With the widespread use of mobile devices and notebook computers, consumers generally require a more ergonomic keyboard that is also light weight and thin. Furthermore, a convenient assembly process with minimal usage of materials is needed to aid in production.

Generally, the structure of a common conventional keyboard mainly consists of a supporting iron plate with openings, a circuit board, and keys disposed within the openings. In the production process, the supporting iron plate is firstly punched to form a plurality of openings. Then, a plurality of scissor-shaped legs is formed through injection molding on the plurality of openings, the keys are assembled above the scissor-shaped legs, and finally, the supporting iron plate is joined with the circuit board. Although the assembly sequence may be slightly different depending on different designs, the primary keyboard structure has generally the same construction: the supporting iron plate is joined with the circuit board after assembly of the key pad structure on the supporting iron plate is completed. Although the supporting iron plate may be directly replaced with a plastic to reduce the weight of the overall keyboard, it is very difficult to effectively reduce the cost and make a thinner profile without changing the basic production process.

Accordingly, it is important to design a key pad structure for a lightweight keyboard with a simple assembly, a thin profile and a low cost, as well as a method for manufacturing the same.

### SUMMARY OF THE INVENTION

The present invention comprises a key pad structure for a keyboard which comprises a circuit board, an elastic portion, a key cap and a supporting structure. In detail, the circuit board has a plurality of through holes. The elastic portion is disposed on the circuit board, while the key cap is disposed above the elastic portion. The supporting structure is partially pivoted within the through holes and below the key cap so that the supporting structure provides the key cap to move in a linear up-and-down motion with respect to the circuit board.

In detail, the circuit board can be activated when the key cap moves downwards from the initial position, and then the key cap moves upwards to return to the initial position from the resilience provided from the elastic portion.

The present invention further comprises a method for manufacturing a key pad structure of a keyboard, which comprises the following steps: firstly, forming a plurality of through holes on a circuit board; then pivoting a supporting structure within the through holes; further, disposing an elastic portion on the circuit board; disposing a key cap above the elastic portion; and forming a key pad structure as described above.

An objective of the present invention is to design a key pad structure that can be assembled simply.

Another objective of the present invention is to provide a key pad structure that has a light weight, thin profile and low cost.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional view of the first embodiment of a key pad structure of the present invention;

FIG. 2 is a cross-sectional view of the second embodiment of the key pad structure of the present invention;

FIG. 3 is a cross-sectional view of the third embodiment of the key pad structure of the present invention;

FIG. 4 is a cross-sectional view of the fourth embodiment of the key pad structure of the present invention;

FIG. 5 is a cross-sectional view of the fifth embodiment of the key pad structure of the present invention;

FIG. 6 is a cross-sectional view of the sixth embodiment of the key pad structure of the present invention; and

FIG. 7 is a flowchart diagram of a method for manufacturing the key pad structure of a keyboard according to the present invention.

### DESCRIPTION OF THE PREFERRED EMBODIMENT

In the following descriptions, the present invention will be explained with reference to embodiments thereof. It shall be appreciated that in the following embodiments and attached drawings, the description of these embodiments is only for purpose of illustration rather than limitation. Meanwhile, in the following embodiments and attached drawings, elements not directly related to the present invention are omitted from depiction. The dimensional relationships among the individual elements in the attached drawings are illustrated only for ease of understanding, but not to limit the actual scale and the actual size.

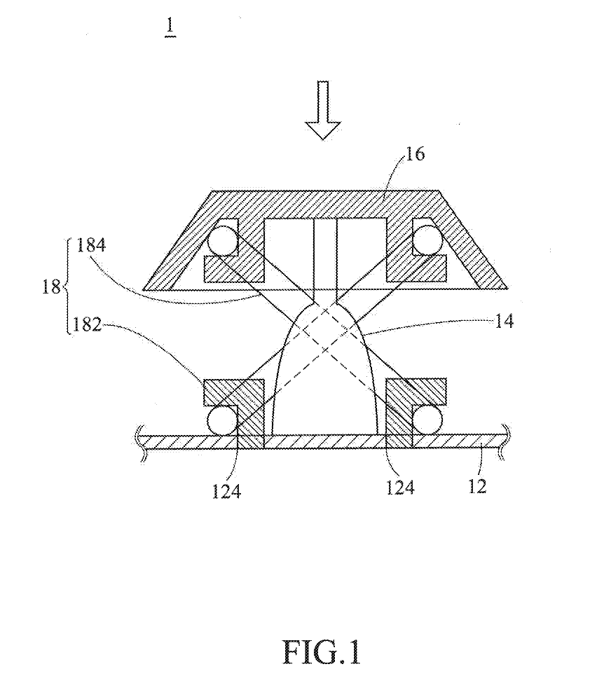

First, with reference to FIG. 1, there is a cross-sectional view of the first embodiment of a key pad structure of the present invention. The key pad structure 1 comprises a circuit board 12, an elastic portion 14, a key cap 16 and a supporting structure 18. The circuit board 12 has a plurality of through holes, and four through holes 124 will be illustrated as an example in this embodiment (only cross sections of two through holes are depicted herein). The elastic portion 14 is disposed on the circuit board 12, the through holes 124 are formed around the elastic portion 14. The key cap 16 is disposed above the elastic portion 14. The supporting structure 18 has four first ends 182 and four second ends 184 (only the cross sections of the two first ends 182 and two second ends 184 are illustrated herein). The first ends 182 are pivoted within the through holes 124 and fixed on the circuit board 12. It shall be appreciated that although the number of first ends 182 is the same as the number of the through holes 124 in this embodiment; the present invention is not limited thereto. The second ends 184 are each a scissors-type supporting element and pivoted below the key cap 16. The second ends 184 function to enable the key cap 16 to linearly move up and down with respect to the circuit board 12.

When a downwards external force (in a direction indicated by an arrow) is applied to the key cap 16 from an initial position, the key cap 16 can move downwards from the initial position to activate the circuit board 12. Then, the key cap 16 moves upwards to return to the initial position by the resilience provided from the elastic portion 14. After being activated, the circuit board 12 can output a signal to a device (not shown) connected to the key pad structure 1 of the present invention.

In detail, the key pad structure of this embodiment is a capacitive key. When the key cap 16 moves downwards from the initial position, the distance between the key cap 16 and the circuit board 12 is shortened so that the capacitance value is increased and the circuit board 12 is turned on. At this point, the circuit board 12 is considered to be activated and outputs a signal.

The term “activate” used herein means a status in which the circuit board 12 is electrically connected with a cooperating electronic element and can transmit a signal therebetween.

This embodiment may also be implemented in such a way that a plurality of keys are disposed adjacent to each other or arranged in a matrix form, and when adjacent ones of the keys are activated, a continuous signal can be generated. For example, activating adjacent keys may be regarded as a directional operation instruction (e.g., rightward or upward). The user may be allowed to define different key pressing or touching sequences, which may be regarded as different operation instructions (e.g., to lock a key). In other words, through the use of the sequence in which the keys are activated, the keyboard can be used as a simple means of human-machine interface manipulation so that the keyboard can be used more flexibly.

The elastic portion 14 of this embodiment may be made of EPDM rubber or silica gel, and may also be a dome-like rubber, a spring coiling, a spring or some other equivalent member. The circuit board 12 of this embodiment may be a printed circuit board assembly (PCBA), a flexible printed circuit (FPC) board, a field-effect transistor circuit board, a single-sided circuit board, a double-sided circuit board, a thin-film circuit board, a ceramic circuit board, or some other equivalent structure.

It shall be appreciated that this embodiment is only illustrative, and may also be implemented in such a way that the elastic portion further comprises a conductive line therein or is made of a conductive rubber. In other words, the key cap can activate the circuit board through the electrical connection between the conductive line or the elastic portion itself and the circuit board.

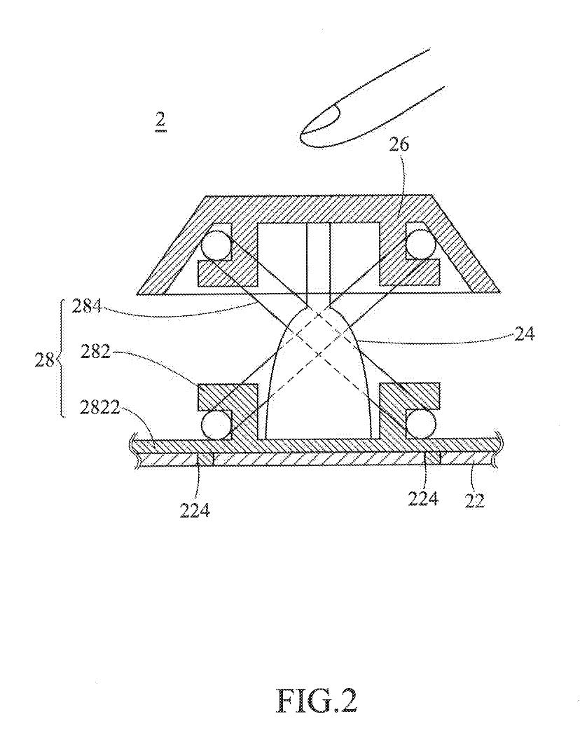

FIG. 2 is a cross-sectional view of the second embodiment of the key pad structure of the present invention. The key pad structure 2 comprises a circuit board 22, an elastic portion 24, a key cap 26 and a supporting structure 28. The second embodiment differs from the first embodiment in that the supporting structure 28 of the key pad structure 2 in the second embodiment has a first end 282 and a second end 284. The first end 282 comprises a flat plate 2822 that is disposed between the circuit board 22 and the elastic portion 24. In detail, the first end 282 with the flat plate 2822 can be directly pivoted above a through hole 224 of the circuit board 22.

It shall be appreciated that because the first end 282 comprises a flat plate 2822 in this embodiment, electronic components (e.g., a line, a processor and so on) on the circuit board 22 can be closely covered. The dustproof and waterproof functions can be further achieved. Similar to the aforesaid embodiment, the second embodiment is also a capacitive keyboard structure. In detail, a finger of the user may be regarded as a conductor, and can interact with the conductor of the circuit board 22 to form a capacitor. When the key cap 26 moves downwards from an initial position, the distance between the finger and the circuit board 22 is shortened to cause an increase of the capacitance value. As a result, a transient current is generated to activate the circuit board 22. Finally, the key cap 26 moves upwards to return to the initial position from the resilience provided from the elastic portion 24.

Moreover, the key pad structure may also be designed as an inductive key in an implementation of this embodiment. In this case, an electromagnetically conductive material needs to be disposed on the key cap. When the user presses the key cap, the electromagnetically conductive structure can interact with the line within the circuit board and activate the circuit board.

It shall be particularly appreciated herein that the first end of the supporting structure mentioned in this specification generally refers to any structure capable of being directly snap-fitted, injected, coupled or adhered to a through hole of the circuit board (i.e., is not merely limited to what is disclosed in this specification). Moreover, the first end of the supporting structure may be integrally formed of a same material, or may be formed into two sections by using two or more materials depending on the different requirements on the strength, but shall not be limited to what is described in this specification.

The operations of other elements of this embodiment are similar to those of the aforesaid embodiment, and thus, will not be further described herein,

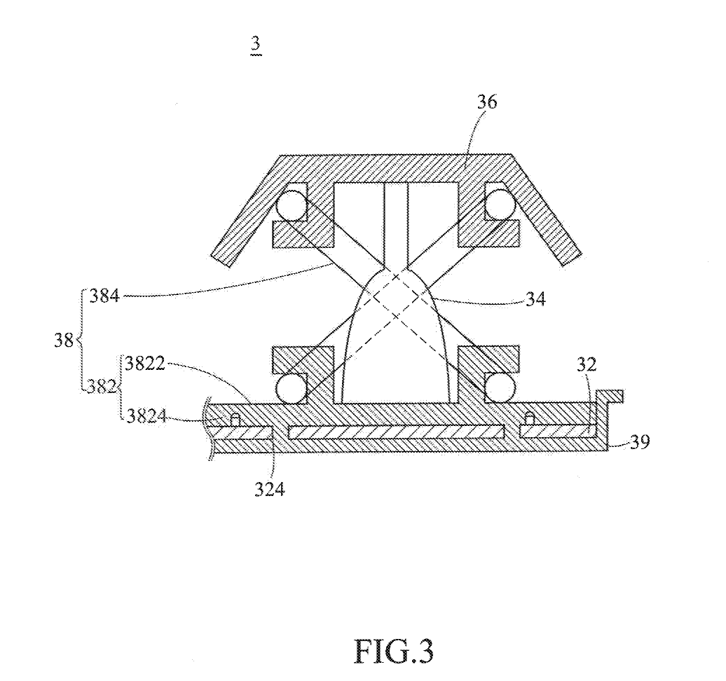

FIG. 3 is a cross-sectional view of the third embodiment of the key pad structure of the present invention. The key pad structure 3 comprises a circuit board 32, an elastic portion 34, a key cap 36 and a supporting structure 38. The supporting structure 38 has a first end 382 and a second end 384. The third embodiment differs from the second embodiment in that a flat plate 3822 of the first end 382 of the key pad structure 3 of the third embodiment is a light guiding panel, and has at least one light source 3824 (e.g., two light sources in this embodiment) disposed therein or has two lateral light source modules (not shown) disposed at two sides thereof respectively. Through the use of the two light sources 3824 disposed in the flat plate 3822, patterns (not shown) or characters (not shown) engraved on the key cap 36 can be highlighted and the need of additionally providing a backlight module can be omitted. Moreover, the flat plate 3822 is joined with the circuit board 32 by means of a plurality of through holes 324. Thereby, the number of procedures can be reduced and the cost can be effectively decreased.

Furthermore, this embodiment further comprises a reinforcing plate 39, while the circuit board 32 is disposed above the reinforcing plate 39. It shall be particularly noted that the reinforcing plate 39 of this embodiment may be formed together with the first end 382 through injection molding to completely cover the circuit board 32. The reinforcing plate 39 can not only reinforce the overall strength of the key pad structure 3 but also completely cover the circuit board 32 and a part of the flat plate 3822 of the first end 382 so that the circuit board 32 is isolated from the outside. This implementation is advantageous in that the waterproof and the dustproof effects can be achieved.

The operations of other elements of this embodiment are similar to those of the previous embodiments, and thus, will not be further described herein.

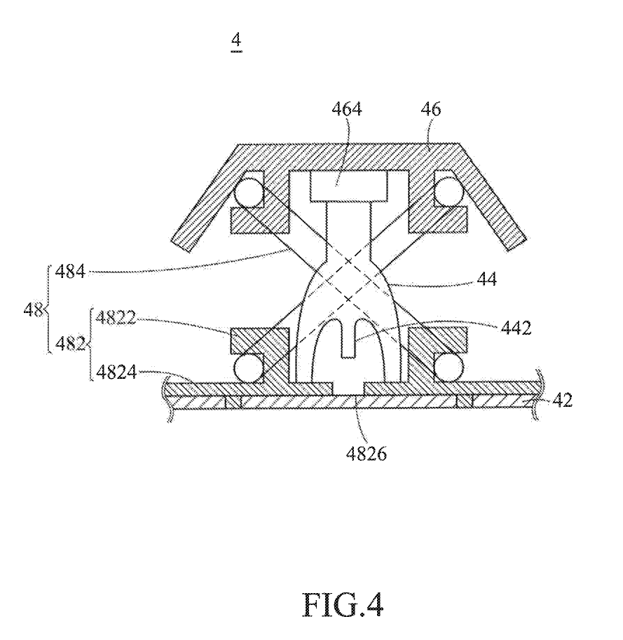

FIG. 4 illustrates a cross-sectional view of the fourth embodiment of the key pad structure of the present invention. The key pad structure 4 comprises a circuit board 42, an elastic portion 44, a key cap 46 and a supporting structure 48. The supporting structure 48 has a first end 482 and a second end 484. The fourth embodiment differs from the second embodiment in that the elastic portion 44 further comprises a protrusion 442, a flat plate 4822 of the first end 482 comprises a hole 4826 which exposes the circuit board 42. The protrusion 442 of the elastic portion 44 is disposed corresponding to the hole 4826.

Similar to the aforesaid embodiments, when the key cap 46 moves downwards from an initial position, the circuit board 42 can be activated by the protrusion 442 through the hole 4826. The key cap 46 moves upwards to return to the initial position. from the resilience provided from the elastic portion 44.

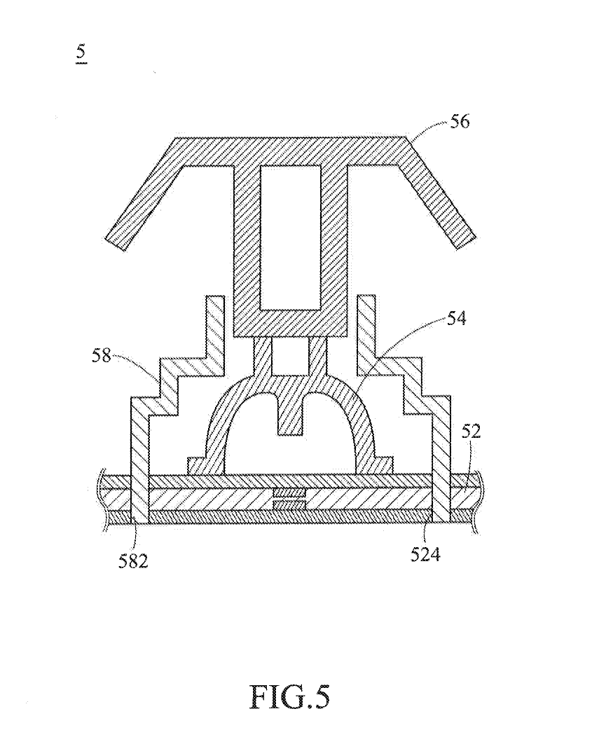

FIG. 5 illustrates a cross-sectional view of the fifth embodiment of the key pad structure of the present invention. Similar to the aforesaid embodiments, the key pad structure 5 comprises a circuit board 52, an elastic portion 54, a key cap 56 and a supporting structure 58. The fifth embodiment differs from the aforesaid embodiments in that the supporting structure 58 of the fifth embodiment is a hollow shell (not shown). The circuit board 52 of the fifth embodiment is a thin-film switch and may be a three-layer thin-film switch or the circuit architecture as shown in FIG. 1.

In detail, the supporting structure 58 of the fifth embodiment has at least one end 582, a containing space (not shown) and an opening (not shown). In this embodiment, the four ends 582 and four corresponding through holes 524 are illustrated as an example (only the cross sections of two through holes and two ends are shown herein). The supporting structure 58 is pivoted within the four through holes 524 by the four ends 582. The key cap 56 is disposed within the opening of the supporting structure 58. The elastic portion 54 is disposed within the containing space of the supporting structure 58.

When a downwards external force is applied to the key cap 56 from an initial position, the key cap 56 can move downwards from the initial position to press the circuit board 52 (a thin-film circuit board) to form an electrical connection therebetween (i.e., the circuit board 52 is activated). Then, the key cap 56 moves upwards to return to the initial position from the resilience provided from the elastic portion 54. After being activated, the circuit board 52 can output the signal to a device (not shown) that is connected to the key pad structure 5 of the present invention.

Furthermore, designing the supporting structure 58 as the hollow shell in this embodiment is advantageous in that the hollow shell can be directly injection molded on the through holes 524 of the circuit board 52, so the number of processing steps and the cost can be reduced.

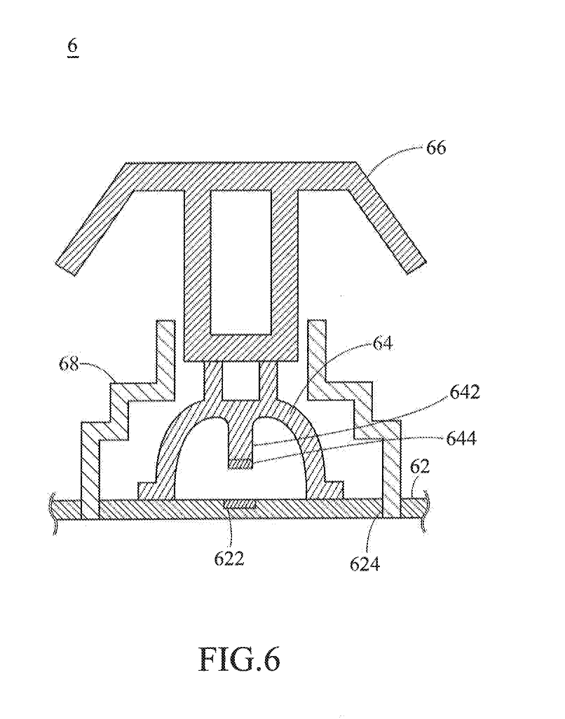

FIG. 6 is a cross-sectional view of the sixth embodiment of the key pad structure of the present invention. Similar to the fifth embodiment, the key pad structure 6 comprises a circuit board 62, an elastic portion 64, a key cap 66 and a supporting structure 68. The sixth embodiment differs from the aforesaid embodiments in that the supporting structure 68 of the sixth embodiment is a hollow shell (not shown), the circuit board 62 of the sixth embodiment has a thin-film switch 622 disposed thereon and may be just a circuit board in other implementations. The elastic portion 64 further comprises a protrusion 642 that is disposed. correspondingly to the thin-film switch 622. The protrusion 642 of the elastic portion 64 further comprises a conductor 644. When the key cap 66 moves downwards from the initial position, the thin-film switch 622 of the circuit board 62 can be activated.

The operations of other elements of this embodiment are similar to those of the previous embodiments, and thus, will not be further described herein.

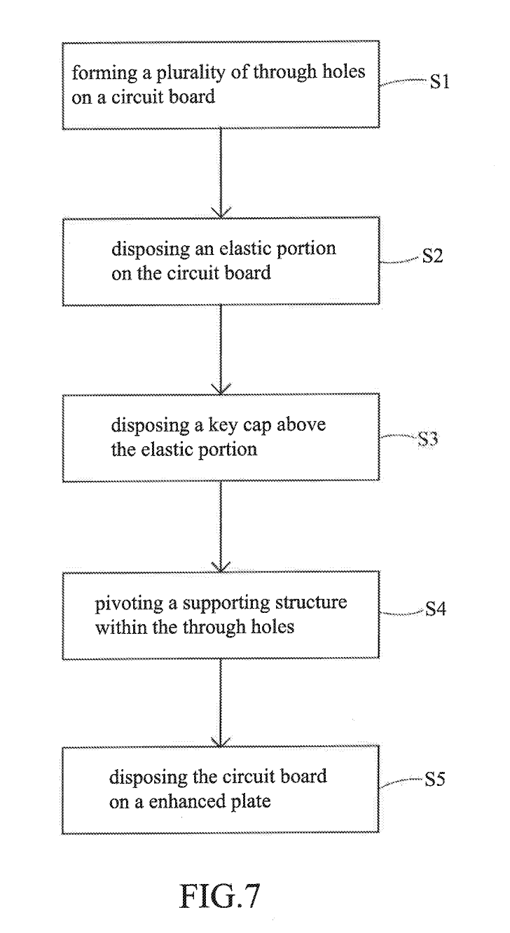

Finally, FIG. 7 illustrates a flowchart diagram of a method for manufacturing the key pad structure of a keyboard according to the present invention. Firstly, a plurality of through holes are formed on a circuit board (step S1), an elastic portion is disposed on the circuit board (step S2), a key cap is disposed above the elastic portion (step S3), and then a supporting structure is pivoted within the through holes (step S4). Finally, the circuit board is disposed on a reinforcing plate (step S5) to form a key pad structure as described in the aforesaid embodiments. Apart from forming the key pad structures of the aforesaid embodiments, this method for manufacturing a key pad structure may also be applied to any other key pad structures which have a circuit board directly punched to generate through holes, but shall not be limited to the aforesaid embodiments.

According to the above descriptions, the present invention provides a key pad construction and a method for manufacturing the same in which a plurality of through holes are directly formed on a circuit board and a supporting structure is directly formed on the through holes. In other words, according to the present invention, the conventional steps of punching a fiat plate, disposing a supporting structure on the flat plate and joining the flat plate to a circuit board can be omitted. Through the aforesaid construction or method, a key pad structure which features a simple assembly process, a light weight, a thin profile and waterproof and dustproof functions can be provided. Also, the present invention can provide a key pad structure which features a light weight, a thin profile and a low cost.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not filly disclosed in the above descriptions, they have substantially been covered in the following claims as appended.

What is claimed is:

1. A key pad structure of a keyboard, comprising:
a circuit board having a plurality of through holes;
an elastic portion disposed on the circuit board;
a key cap disposed above the elastic portion; and
a supporting structure, being partially pivoted within the through holes and below the key cap so that the supporting structure allows the key cap to move in a linear up-and-down motion with respect to the circuit board,
wherein the circuit board is activated when the key cap moves downward from an initial position, and then the key cap moves upwards so as to return to the initial position from a resilience provided from the elastic portion.

2. The key pad structure of the keyboard as claimed in claim 1, wherein the supporting structure has at least one first end and at least one second end, and the first end is pivoted within the through holes and the second end is pivoted below the key cap.

3. The key pad structure of the keyboard as claimed in claim 2, wherein the at least one first end is four first ends disposed within the through holes and fastened on the circuit board.

4. The key pad structure of the keyboard as claimed in claim 2, wherein the first end of the support structure further comprises a flat plate that is disposed between the circuit board and the elastic portion.

5. The key pad structure of the keyboard as claimed in claim 4, wherein the flat plate is a light guiding panel that further comprises at least one light source.

6. The key pad structure of the keyboard as claimed in claim 4, wherein the flat plate comprises at least one hole that is capable of exposing the circuit board, and the elastic portion further comprises a protrusion disposed corresponding to the hole.

7. The key pad structure of the keyboard as claimed in claim 2, wherein the second end of the supporting structure is a scissors-type supporting element.

8. The key pad structure of the keyboard as claimed in claim 1, wherein the supporting structure is a hollow shell and has at least one end, a containing space and an opening, wherein the supporting structure is pivoted within the through holes by the end, the key cap is disposed within the opening, and the elastic portion is disposed within the containing space.

9. The key pad structure of the keyboard as claimed in claim 1, wherein the elastic portion is a dome-like rubber, a spring coiling or a spring.

10. The key pad structure of the keyboard as claimed in claim 1, further comprises a reinforcing plate so that the circuit board is disposed above the reinforcing plate.

11. The key pad structure of the keyboard as claimed in claim 1, wherein the circuit board further comprises a thin-film switch, and the thin-film switch of the circuit board is activated when the key cap moves downward from the initial position.

12. The key pad structure of the keyboard as claimed in claim 11, wherein the elastic portion further comprises a protrusion provided with a conductor, and the protrusion is disposed corresponding to the thin-film switch.

13. The key pad structure of the keyboard as claimed in claim 1, wherein the circuit board is a single-sided circuit board, a double-sided circuit board, a thin-film switch, a ceramic printed circuit board, a printed circuit board assembly, a flexible printed circuit board, a field-effect transistor circuit board or a printed circuit board.

14. A method for manufacturing a key pad structure of a keyboard, the method comprising the steps of:
(a) forming a plurality of through holes on a circuit board;
(b) disposing an elastic portion on the circuit board;
(c) disposing a key cap above the elastic portion;
(d) pivoting a supporting structure within the through holes; and
(e) forming a key pad structure.

15. The method as claimed in claim 14, wherein the step (d) further comprises the step (d2) of disposing the circuit board on a reinforcing plate.
